(19) United States
(12) Patent Application Publication
(10) Pub. No.: US 2005/0080692 A1
(43) Pub. Date: Apr. 14, 2005

(54) System and method for distributing payments between multiple accounts

(76) Inventors: Amarjit Padam, Lexington, MA (US); Derek Holmes, Boxborough, MA (US); James E. Forrest, Bloomfields, MI (US); Victoria Nipple, Avon, OH (US)

Correspondence Address: Scott D. Wofsy;Edwards & Angell, LLP, P. O. Box 9169, Boston, MA, 02209, US

(21) Appl. No.: 10/756,571

(22) Filed: Jan. 13, 2004

Related U.S. Application Data
(60) Provisional application No. 60/510,510, filed on Oct. 10, 2003.

(51) Int. Cl. G06F 17/60

(52) U.S. Cl. 705/30

(57) ABSTRACT

A system and method for allowing linked account types to be associated with each plan participant. The plan participants create and select rules that govern distributions from the linked account types. Thus, funds may be drawn from a plurality of accounts to pay for a single point-of-service transaction. Subsequent point-of-service transactions may be paid by drawing on a plurality of accounts in different ratios as governed by the selected rules.

### CROSS-REFERENCE TO RELATED APPLICATION

This application claims the benefit of priority to U.S. Provisional Patent Application No. 60/510,510 filed Oct. 10, 2003, which is incorporated herein by reference.

### BACKGROUND OF THE INVENTION

1. Field of the Invention

The subject disclosure relates to systems and methods for administering flexible spending accounts to pay for qualified purchases, and more particularly to an improved system and method for creating multiple accounts of various types with user set criteria to govern distributions from multiple accounts.

2. Background of the Related Art

Even though a person has health care insurance, many health care related costs may not be reimbursed by the health care plan. Typical examples of out-of-pocket expenses include co-pays for office visits, chiropractors, homeopathic consultations and remedies, prescriptions, eyeglasses, contact lenses, saline solution and over-the-counter drugs. In order to pay for certain uncovered expenses with pre-tax dollars, flexible spending accounts (hereinafter “FSA”) have been established under federal guidelines.

A FSA is an account funded by the participant with pre-tax money to reimburse the participant for qualified medical and related expenses which would otherwise be paid directly by the participant. The cost savings of FSAs make having one very desirable. In the year 1993, less than 4% of employers implemented FSAs. In the year 2003, 56% of employers offered FSAs as part of their benefit package and projections are for upwards of 95% of employers to offer FSAs to their employees.

Generally, rollover of FSA money is not allowed. The participant needs to properly estimate the anticipated annual uncovered expenses because unused FSA money returns to the employer. Consequently, many participants intentionally underfund their FSAs to insure that no money is forfeited. Additionally, expenses may simply exceed expectations. To cover the shortfall of an FSA, additional accounts are available. Health reimbursement accounts (hereinafter “HRAs”) may be funded by an employer and/or a plan participant to facilitate covering the shortfall. Examples of HRAs are a personal health account (hereinafter “PHA”), a personal dependent care account (hereinafter “PDA”) and a personal transportation account (hereinafter “PTA”). Employers can even elect to allow a portion or all of the HRA to be rolled over from year to year.

Due to the significant administration task of processing receipts for reimbursement from FSAs and HRAs, employers have recognized the need for centralized processing for such accounts. Typically, employers contract for the administration to be done by a third party administrator (hereinafter “TPA”). TPAs maintain FSAs for the employees enrolled in the program. Employees pay for unreimbursed expenses out-of-pocket and submit a receipt with an eligibility form to the TPA. The TPA determines if the expense is appropriate based upon merchant category codes (hereinafter “MCC”) on the receipt. If appropriate, the TPA reimburses the employee with a check drawn against that participant's FSA.

Several systems have been developed to automate the process for administering FSAs such as U.S. Patent Application No. 2002/0198831 to Patricelli et al., U.S. Patent Application No. 2002/0147678 to Drunsic and U.S. Patent Application No. 2003/0061153 to Birdsong et al., each of which is incorporated herein by reference in its entirety to the extent they do not conflict with the subject invention.

Patricelli et al. disclose a system for authorizing payment from a FSA at the point of service (hereinafter “POS”). However, the system of Patricelli et al. has drawbacks in that multiple accounts for each participant cannot be accomodated. Moreoever, with multiple accounts such as a FSA and a plurality of HRAs associated with each participant, the processing burden is multiplied and the need for efficient administration is magnified. Further, the MCC that pharmacy benefits managers (hereinafter “PBM”) use to catagorize purchases of goods and services are not unique between various areas such as FSAs, PHAs, PDAs and PTAs. Still further, many reimbursable goods may be purchased that are not processed through a PBM, and, alternatively, many unreimbursable goods may be purchased at a pharmacy that has a proper MCC. Thus, the automation channels in the system of Patricelli et al. are rendered obsolete and an alternative method for processing the reimbursable expenses must be used.

Drunsic discloses a method for adjudication that establishes a shadow account for the sponsor of the plan. Transactions are posted to the shadow account pending adjudication to prevent erroneously posting the transactions to the FSA in violation of IRS guidelines. The system of Drunsic has drawbacks in that the administrative burden of establishing and maintaining shadow accounts reduces the efficiency of the method. Birdsong et al. disclose an electronic debit card adjudication system that still requires submission and review of the paper receipt.

There is a need, therefore, for an improved system and method which permits TPAs to efficiently and accurately administer a plurality FSAs and HRAs associated with an employee according to employee defined criteria. It would also be advantageous for the system and method to integrate the ability to process reimbursements for expenses that are not purchased at the pharmacist, i.e. a PBM does not generate POS transaction data for adjudication.

### SUMMARY OF THE INVENTION

The present invention is directed to a method for processing transactions associated with an employee, the method includes the steps of establishing at least two linked accounts for the employee and at least one rule for governing how funds are withdrawn from the at least two linked accounts. Funds are received funds for the at least two linked accounts. A POS transaction associated with the employee is received and parsed into first and second electronic transactions according to the at least one rule. Payment is authorized for the first electronic transaction from one of the at least two different accounts for the employee and payment of the second electronic transaction is authorized from a different account than the one that the first electronic transaction was authorized from.

In another preferred embodiment, a computer readable medium causes a distributed computing environment to utilize a collection of tiers to fund a single POS transaction. The distributed computing environment has client computers and server computers. When running the program contained in the computer readable medium, the distributed computing network receives data relating to a POS transaction by a cardholder, the data including at least one monetary amount associated with a MCC, and determines whether the at least one monetary amount is reimbursable under IRS guidelines. The distributed computing network also determines whether the at least one monetary amount is reimbursable according to rules that govern a collection of tiers associated with the cardholder and parses the at least one monetary amount into sub electronic transactions according to the rules. Each sub electronic transaction is processed in a different tier of the collection.

In another embodiment, a computer for distributing payments between a plurality of accounts associated with a plan participant memory for storing a program having instructions for creating a plurality of accounts being associated with and accessed by a plan participant, receiving a POS transaction of the plan participant and parsing the POS transaction into electronic transactions for processing from different accounts within the plurality of accounts. The memory also includes data related to the plan participant and the plurality of accounts. A processor is operatively connected to the memory for running the program and accessing the data as necessary.

It should be appreciated that the present invention can be implemented and utilized in numerous ways, including without limitation as a process, an apparatus, a system, a device and a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings wherein:

FIG. 1 is a schematic overview of an environment in which an embodiment of the subject invention may be implemented.

FIG. 2A is a schematic of a server for storing data in accordance with the embodiment of FIG. 1.

FIG. 2B is a schematic of a server for executing a program for processing data in accordance with the embodiment of FIG. 1.

FIG. 3 is a flowchart illustrating an embodiment of a process for distributing payments between multiple accounts in accordance with the subject invention.

FIG. 4 is an organizational diagram of the relationship between a collection of linked account types in accordance with the subject invention.

FIG. 5 is a somewhat schematic view of three transactions being paid by distributions from a collection of linked account types in accordance with the subject invention.

### DETAILED DESCRIPTION OF PREFERRED EMBODIMENTS

The present invention overcomes many of the prior art problems associated with processing payments for transactions from a plurality of accounts. The advantages, and other features of the systems and methods disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

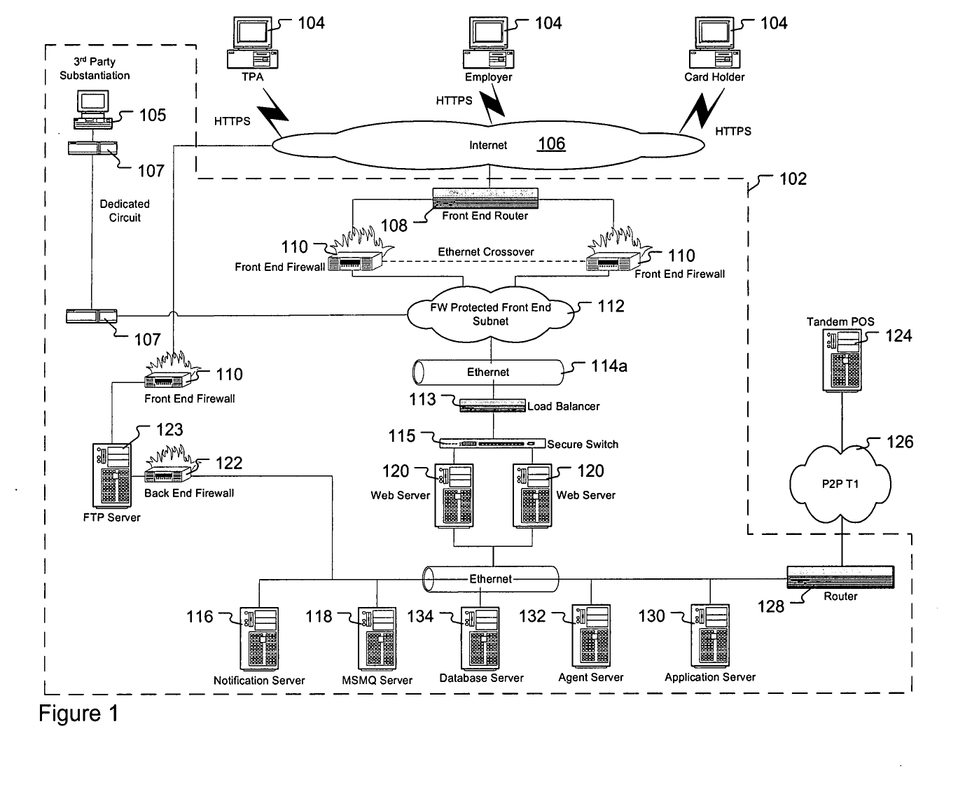

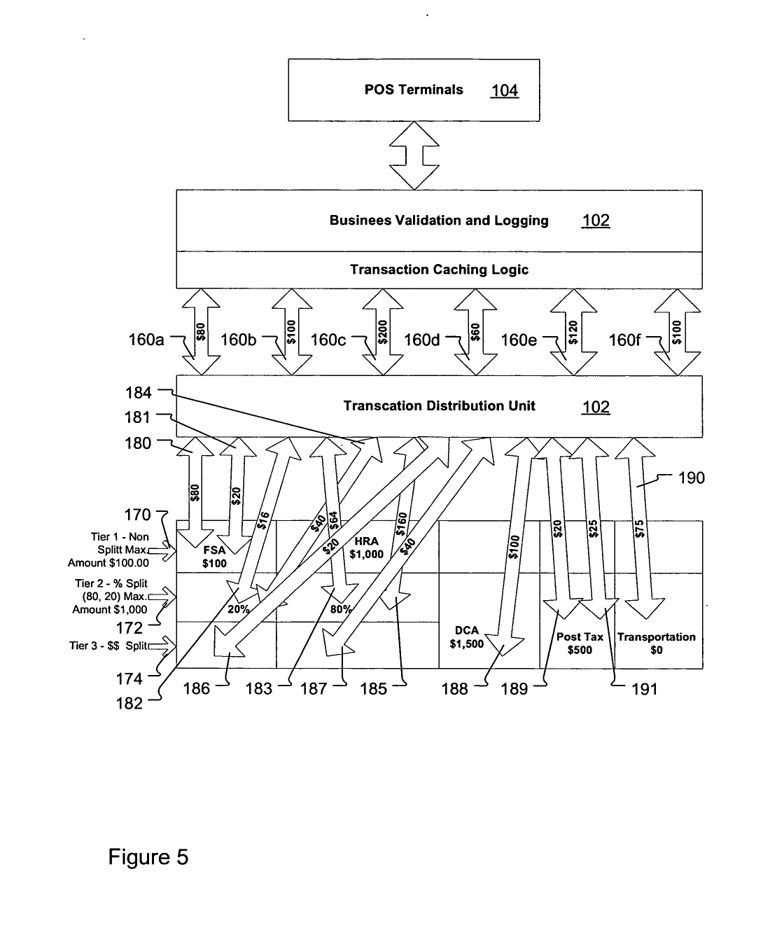

Referring to FIG. 1, a schematic configuration of an environment for a preferred embodiment is referred to generally by the reference numeral 100. A program runs within the environment 100 to execute instructions that allow a plurality of accounts types to be associated with and accessed by each plan participant. The plan participants are typically employees establishing the plurality of accounts through their employer. The plurality of accounts are referred to as linked account types (hereinafter “LAT”) or tiers. A relationship exists between the plurality of accounts as will be described in detail with respect to FIG. 5. The plan participant creates rules that govern distributions from the LAT to define the relationship amongst the LAT. Funds may be drawn from a plurality of accounts to pay for one or more POS transactions as governed by the rules. It will be appreciated that POS transactions typically involve provision of goods and/or services.

The environment 100 includes a network 102 for access by a plurality of clients 104 via the Internet 106. For clarity and simplicity in FIG. 1, clients 104 may include TPAs, employers and plan participants, as shown, among others. Plan participants are generally employees and their dependents that have been issued a card in accordance with the subject invention and, therefore, the terms plan participant and employee are used interchangeably herein. The cards issued to the plan participants are associated with one or more tiers established for the plan participant. In the preferred embodiment, the data related to the POS transaction is derived by processing the card as if the card were a traditional credit card. For goods and services that utilize PBMs such as prescription drugs, the PBMs provide information to the network 102 about the POS transaction at a pharmacy. In the following description, a POS transaction at a pharmacy is described.

It will be appreciated that server refers to the program that is managing the associated resources and that several servers may be incorporated within one physical computer or alternatively multiple computers may be coupled to execute a single server program in order to accomplish the desired performance. The clients 104 may be stand alone desktop personal computers, part of a network and like arrangements. The following description will refer to servers in combination with the clients 104 as is standard terminology within the art.

The network 102 has a router 108 for sending and receiving information as data packets between the network 102 and Internet 106. The information passes through a first firewall 110 designed to prevent unauthorized access and use of the network 102. A firewall protected subnet 112 provides communication to a plurality of servers. It is envisioned that the subnet 112 may include a dmz lan switch (not shown) acting as a buffer that filters and forwards information between the firewall 110 and an Ethernet bus 114a of the network 102. In another embodiment, the subnet 112 is a single computer.

A load balancer 113 distributes traffic between a plurality of Web servers. A secure lan switch 115 connects between the load balancer 113 and Web servers 120 to protect the data stored in the network 102. The Ethernet bus 114a and 114b is the architecture or bus type that supports simultaneous communication between the components connected thereto in order to form the network 102. The Ethernet bus 114a connects to Web servers 120 for fetching Web pages and serving the Web pages up to a browser software application running on other servers within the network 102 and on the clients 104.

A notification server 116 is connected to the Ethernet 114b for providing email correspondence such as notices, alerts and the like to clients 104. A message queue server 118 also connects to the Ethernet bus 114b so that inbound files can be downloaded from the Internet 106, (e.g., the clients 104) and outbound files can also be uploaded to the other servers within the network 102. A database server 134 is connected via the Ethernet 114b for storing records in a plurality of relational databases. The records include data for each plan participant, business rules, PBMs, card activity, health plans, tiers, and other information necessary for the subject invention.

An agent server 132 and application server 130 are also connected via the Ethernet 114b. The agent server 132 facilitates communication with third parties such as the third party substantiation client 105. Preferably, the third party substantiation client 105 is connected to firewall protected subnet 112 via a dedicated circuit 107. In effect, the agent server 132 acts like a router to control the flow of data between the other servers and external servers and clients. The application server 130 acts as a bridge between the Web servers 120, database server 134 and agent server 132.

A router 128 connects to the Ethernet 114b for sending and receiving information as data packets between the servers 116, 118, 120, 130, 132 and 134 and a point-to-point (“P2P”) network 126. Preferably, the P2P network 126 is connected to the Internet by a high speed phone connection such as a T-1 line. The network 102 communicates with a fault tolerant POS server 124 via the P2P network 126. The fault tolerant POS server 124 receives, processes and sends information to a credit card company across the Internet 106. Preferably, the information includes, without limitation, data gathered by swiping a card issued to a plan participant.

A second back end firewall 122 connects between the Ethernet bus 114b and the FTP server 123. The back end firewall 122 further protects the servers 116, 118, 123, 130, 132 and 134 and data related to the plan participants, POS transactions and other confidential information from unwanted access and corruption. In another embodiment, a secure lan switch further enhances the security of the network 102. As the name suggests, the File Transfer Protocol (“FTP”) server 123 is used on the Internet for exchanging files. FTP is a protocol similar to Hyper Text Transfer Protocol (“HTTP”) for transferring Web pages from a server to a browser running on a client and for transferring electronic mail and the like across the Internet 106. The FTP protocol uses the Internet's TCP/IP protocols to enable data transfer. In short, the FTP server 123 downloads and uploads files.

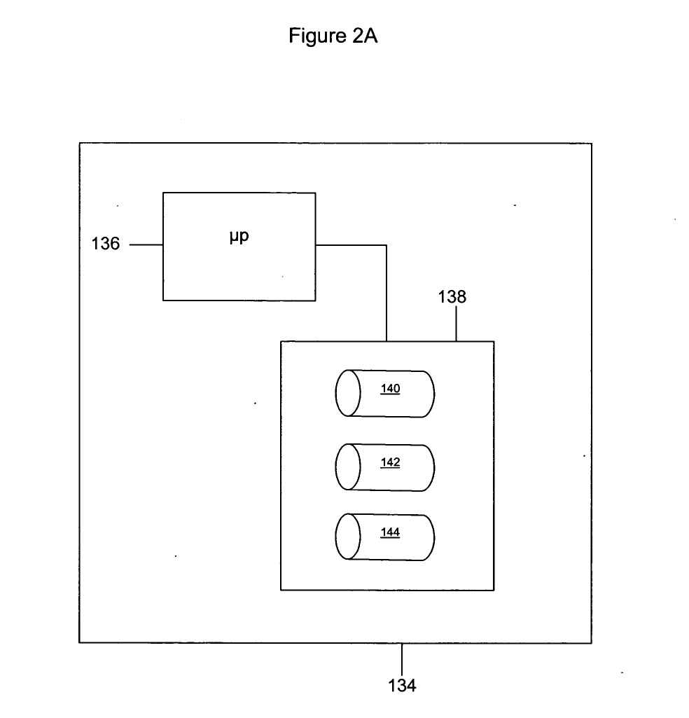

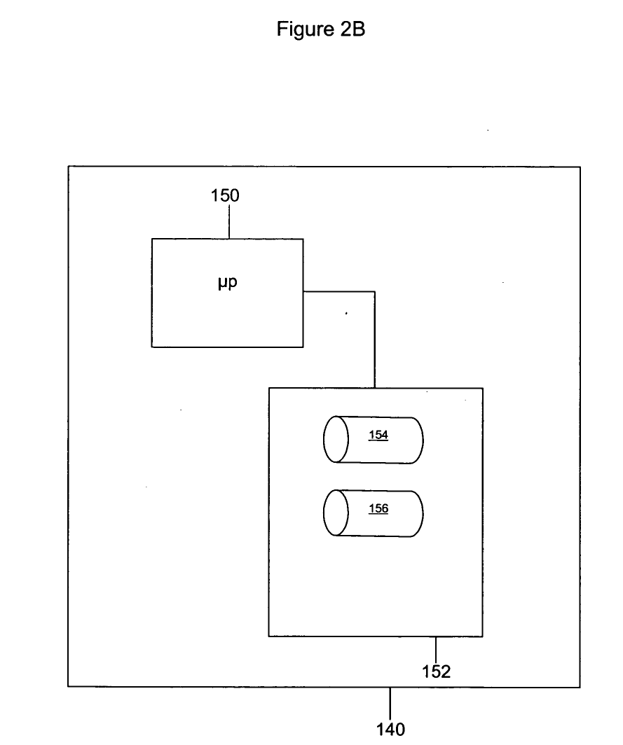

Referring now to FIG. 2A, the database server 134 warehouses the information required to support the functions of the network 102. The database server 134 is exemplary in that the database server includes a processor 136 in communication with memory 138. The memory 138 stores a program 140 that is the instruction set to allow the database server 134 to perform the functions in accordance with the subject disclosure. The memory 138 also stores a plurality of databases, relational and otherwise as required. For example, an employer database 142 includes information relating to employers such as tax identification number, plan participants, associated PBMs and the like. A plan participant database 144 includes information relating to the users of the subject invention such as card numbers, account types, account balances, the rules for distribution of account funds and data related to POS transactions. The databases 140, 142, 144 are relational databases as would be known to those of ordinary skill in the pertinent art. It is envisioned that servers 116, 118, 120, 123, 124, 132 and 134 would have similar hardware configurations and, for simplicity, are not further described herein.

Referring now to FIG. 2B, in an alternate embodiment a single server 148 performs all of the necessary storage and execution necessary to implement the subject invention. The server 148 would include a processor 150 in communication with memory 152. The memory 152 is for storing a program 154 that is the instruction set to allow the server 148 to perform the functions in accordance with the subject disclosure. One of the features that the program 154 allows the server 148 to perform is to act as a transaction distribution unit as described below with respect to FIG. 5. The memory 152 also stores a plurality of databases, relational and otherwise as required. In particular, a transaction database 156 includes history information relating to past POS transactions. Table 1 includes an exemplary list of the databases and types of data that are stored in the database server.

TABLE 1

Table Name
ACCT_TYPE
ACCT_TYPE_AUDIT
ACCT_TYPE_MTC
ACH_EMPR_ACCOUNT
AGENT
AGENT_ERROR
AGENT_HISTORY
AGENT_NOTIFY
ALERT_MASTER
ALERT_NOTIFICATION
ALERT_NOTIFICATION_AUDIT
ALERT_USER
ALERT_USER_AUDIT
APP_STATUS_CODE
ATA_PLAN
ATA_PLAN_DESIGN
ATA_PLAN_DESIGN_TIER
ATA_STATUS_CODE
AUTO_DEPOSIT
AUTO_DEPOSIT_AUDIT
BENEFIT_PLAN
BENEFIT_PLAN_AUDIT
BIN_MASTER
CARD_EXPIRE_MONTH
CARD_GENERATION
CARD_GENERATION_AUDIT
CARD_SECOND_LINE
CARD_SHIPMENT
CARD_SHIPMENT_AUDIT
CARD_STOCK
CARD_STOCK_AUDIT
CARD_TYPE
CARDHOLDER_RECEIPT_NOTIFICATION
CHECK_COMMENT
CHECK_COMMENT_AUDIT
CHECK_SIGNATURE
CHECK_SIGNATURE_AUDIT
CONV_ERROR_CODE
CONV_KEY_MAP
CONV_KEY_MAP_BANK_ACCT
CONV_KEY_MAP_CHK_FDETAIL
CONV_KEY_MAP_CHK_FILE
CONV_KEY_MAP_CHK_LAOYOUT
CONV_KEY_MAP_EMPE_ACCT
CONV_KEY_MAP_EMPR_ACCT
CONV_KEY_MAP_PROFILE
CONV_KEY_MAP_REIMB_FIELD
CONV_KEY_MAP_RNOT
CONV_KEY_MAP_RPT_NOT
CONV_KEY_MAP_TXN
CONV_KEY_MAP_USER_ID

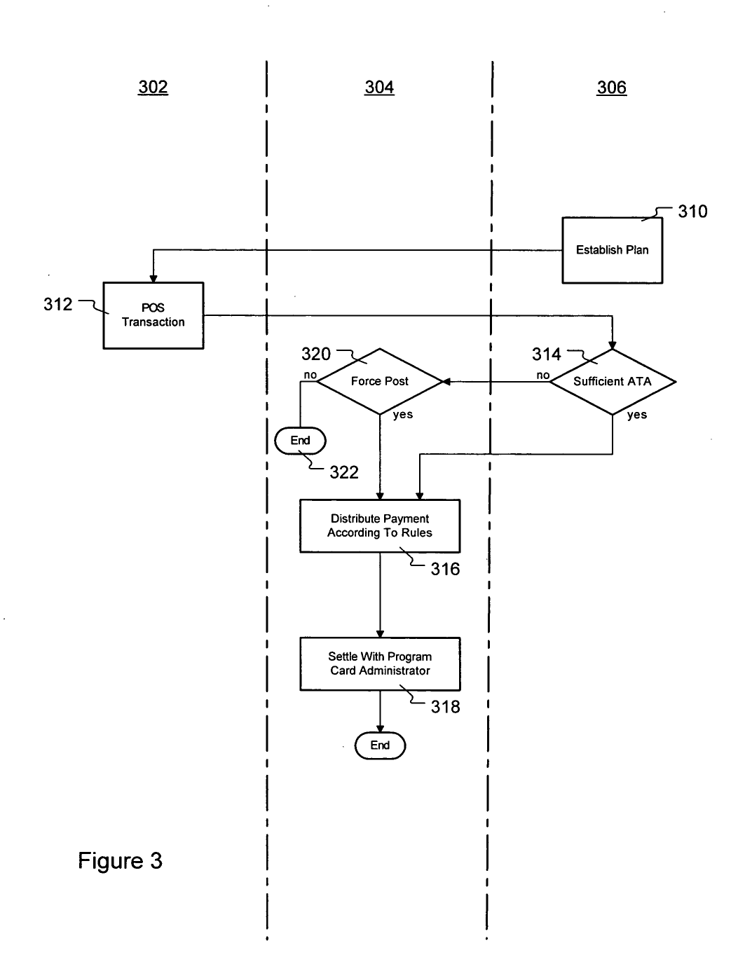

Referring to FIG. 3, a flowchart 300 indicating the steps performed in accordance with a preferred embodiment is shown. To illustrate where the associated step occurs, the steps have been arranged in different columns 302, 304 and 306. Column 302 identifies that an associated step occurs substantially at the POS. Column 304 identifies that an associated step occurs substantially within the network 102. Column 306 identifies that an associated step occurs substantially by use of a client 104.

Initially, at step 310, an employer offers a collection of LAT or tiers (hereinafter “a Plan Design” or “COLLAT”) to their employees. The employer contracts with a TPA to administer the associated plan. The TPA may maintain network 102 or subcontract the maintenance of the network 102 to another provider. The employee selects a desired set of accounts and the rules that govern withdrawal of funds therefrom. The accounts may be funded by the employee, the employer and combinations thereof. The employee is issued a program card under the Plan Design. Typically, the program card would include a magnetic strip containing the required information for access at the POS by swiping the program card through a reader at the POS as is well known to those of ordinary skill in the pertinent art.

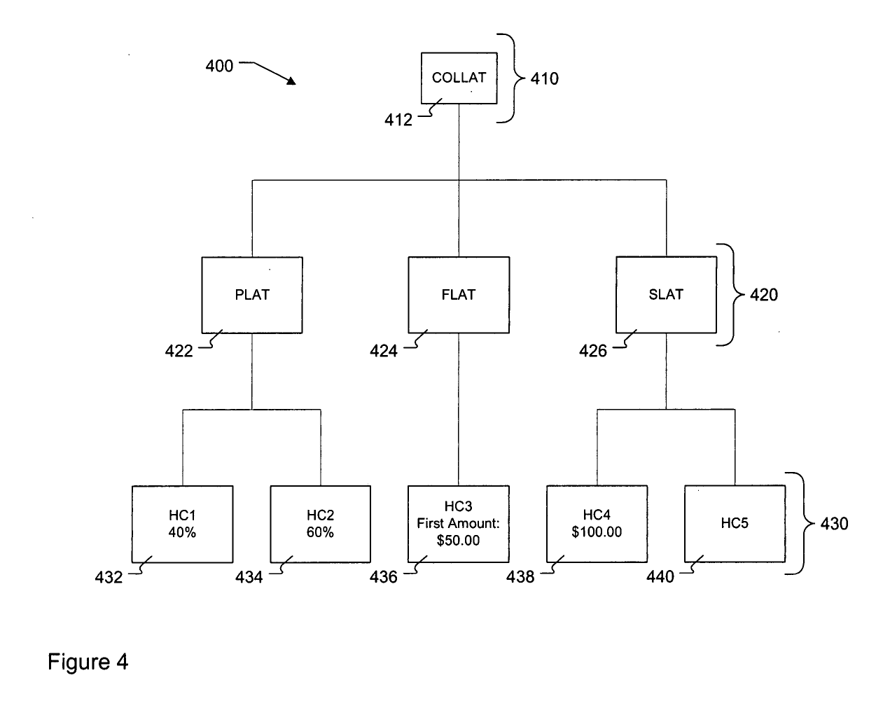

Referring to FIG. 4, for illustration, an organizational chart 400 of a Plan Design for an exemplary employee is shown. Within the chart 400, there are three levels 410, 420, 430. Level 410 is a Plan Design level having a COLLAT 412 associated with an exemplary employee and her program card. Level 420 is a collection of three different types of tiers or LAT 422, 424 and 426. POS transactions can be split across multiple account types by percentages (e.g., a percentage rule) or split amounts (e.g., a split amount rule) depending upon the rules associated with the LAT 422, 424, and 426.

The chart 400 further drills down to level 430 that has five different of accounts 432, 434, 436, 438 and 440 associated with the tiers 422, 424 and 426 as shown. The accounts 432, 434, 436, 438 and 440 are each health care accounts with designations “HC1”, “HC2”, “HC3”, “HC4” and “HC5”, respectively.

Accounts 432 and 434 (HC1 and HC2) form a tier 422 having a percentage based rule to determine the withdrawal of funds to pay for a POS transaction. This arrangement is referred to as a percentage LAT (hereinafter “PLAT”) or Percentage Split tier. The total percentage of the combination of PLAT should equal 100%. Accounts 438 and 440 (HC4 and HC5) form a tier 426 having a split amount based rule to determine the withdrawal of funds to pay for a POS transaction. This arrangement is referred to as a split amount LAT (hereinafter “SLAT”) or Dollar Split tier. In a Dollar Split tier, electronic transactions equal to the dollar split amounts must be created before another account can be debited. Account 436 (HC3) forms tier 424 having a defined parameter called a flat amount. Based upon employee selected priorities for withdrawal, the flat amount may be designated for withdrawal to pay for a POS transaction. Accounts with flat amount rules are referred to as flat amount LATs (hereinafter “FLATs”) or Non-Split tiers. Preferably, the FLAT 436 has funds withdrawn initially until the flat amount is exhausted. In another embodiment, the FLAT may supply funds after a certain threshold of expenditures or as a last resort.

Referring again to FIG. 3, at step 312, the employee makes a POS transaction at a provider of goods or services. For this example, the provider of goods and services will be a pharmacy and the goods are a prescription drug and a bottle of saline solution. When the employee drops off the prescription, the pharmacy sends information regarding the employee to the PBM. In response, the PBM confirms that the plan participant is covered and provides the pharmacy with the employee's co-payment for the prescription drug. The PBM also generates a record of the POS transaction that is sent to the database server 134 for storage in database 144. In another embodiment and/or for other goods and service providers, the provider may send information via a client 104 directly to the entity maintaining the network 102 or to the third party substantiation client 105.

When the employee returns to pick up her prescription, she also purchases a bottle of saline solution. The pharmacy accepts the employee's program card and accesses the information contained in a magnetic strip thereon. The POS transaction information is submitted to the credit card company for approval. Preferably, the POS transaction information includes a program card number and expiration date, a co-payment amount, the MCC and the SKU number for each item.

At step 314, the program card administrator (e.g., a company such a MASTERCARD® Int'l. Inc.) will verify basic information such as, without limitation, whether or not the employee and her card are active, the maximum transaction amount been exceeded, the plan design year is active, the merchant type code is valid for any plan design to which the cardholder belongs, and the year-to-date transaction amount been exceeded. The program card administrator will also compare the co-payment amount with the available transaction amount (hereinafter “ATA”) and any maximums associated with the plan design to determine if the POS transaction can be approved. The ATA is the minimum amount of several variables such as the disbursable total balance, the account type maximum transaction amount, account type total transaction year-to-date, a MCC maximum transaction amount and a MCC total transaction year-to-date. The program card administrator provides the POS transaction data to the Fault Tolerant server 134 for storage within database server 134 in network 102. It is envisioned that the program card administrator would send and receive data with the network 102 on a periodic basis such as nightly. In another embodiment, the data is provided to the program card administrator on a real-time basis for extra security and speed.

At step 316, the network 102 determines if the POS transaction amounts are applicable to the plan participants FSAs, HCRA, DCRA, bank checking account or any other type of account associated with her program card. For the charge related to the prescription drug, the network 102 may verify that the POS transaction amount matches a figure received from the PBM to adjudicate payment from an FSA.

For the charge related to the bottle of saline solution, no information is received from the PBM, so the third party substantiation client 105 facilitates adjudication. The third party substantiation client 105 receives a data feed from the provider of goods and services. The data feed includes, without limitation, detailed information regarding the POS transaction such as the program card number, SKU number for each item purchased, MCC and the like. Based upon the SKU number for the bottle of saline solution, one can determine whether or not the expense is reimbursable via the Plan Design by comparing the goods or services to the IRS guidelines. If the goods are not appropriate for disbursement from the Plan Design, then the expense is not adjudicated and reimbursement from the employee, debiting from a post tax account, posting against a credit line and the like is utilized to reconcile the charge. As a result, the conditions upon which a transaction will be denied are very limited in order to avoid the high levels of customer satisfaction associated with denials. In a preferred embodiment, the third party substantiations are based on the SKU number.

In a preferred embodiment, the POS transaction data is received on a periodic basis. In another embodiment, the POS transaction data is received in real-time to allow POS transaction-by-transaction processing of the expenses that are substantiated by a third party or the network 102. In this way, although the POS transaction is authorized, the subsequent substantiation can occur within minutes of the transaction. The third party substantiation may alternatively be based upon plan participant identification number, account status and the associated available transaction amount.

Once approved, the expenses that are approved by third party substantiation are posted to accounts just like claims adjudicated by a PBM. Such an expense may not be substantiated in which case the amount will be processed like a normal credit card charge, deducted from a bank account as directed by the plan participant, reconciled by a traditional FSA process and the like. In another embodiment, the network 102 receives a direct feed of data from the provider of goods and services and, thus, the role of the third party substantiation client 105 may be filled by the TPA or administrator of network 102 if different entities.

Still referring to step 316, upon approval of withdrawal of funds to pay for the POS transaction, the network 102 distributes money from the Plan Design associated with the employee to pay for the POS transaction. If the Plan Design is as shown in FIG. 4, top priority for the plan participant is the first amount of HC3, e.g., $50. The second priority (i.e., the second LAT from which funds will be withdrawn) is the PLAT and the third priority is the SLAT. To be paid from different accounts, the POS transaction amount is parsed to create two or more electronic transactions. The POS transaction amount that has been parsed is a split transaction. Of course, the POS transaction amount may actually be the sum of two or more approved expenses such as multiple co-payments occurring in one visit to the pharmacist, a co-payment plus an over-the-counter approved expense and the like. In our example of a prescription co-payment plus a bottle of saline solution, the amount would likely be under $50 and, thus, the expense would simply be taken from the HC3 account.

For another example, a plurality of prescription drugs are purchased at a pharmacy. The pharmacy contacts the PBM to determine that the total POS transaction co-payment is $300. The network 102 parses the POS transaction co-payment into at least three electronic transactions according to the Plan Design. In particular, an electronic transaction for $50 is created to allow taking $50 from account 436 (HC3 with first priority) leaving $250 to be taken from the remaining COLLAT. The second priority is the PLAT 422 wherein the percentage taken from account 432 (HC1) and account 434 (HC2) is 40% and 60%, respectively. If the remaining amount outstanding, $250, is to come from the PLAT 422, $100 would be withdrawn from HC1 and $150 would be withdrawn from HC2. Thus, two more electronic transaction of $100 and $150 would be created for a total of three electronic transactions.

In an alternative scenario, account 432 (HC1) and account 434 (HC2) may only have balances of $80 and $120, respectively. In such a case, the network 102 would look to the SLATs for the remaining balance of $50. Since account 438 (HC4) is set up to release $100 prior to accessing account 440 (HC5), a fourth electronic transaction would be created for the remaining deficiency of $50. Payment for the fourth electronic transaction would be withdrawn from account 438 (HC4). If the remaining deficiency had exceeded the $100 limit associated with account 438, the remainder would generate a fifth electronic transaction to be paid from account 440 (HC5).

It can be seen that provided the ATA exceeds the POS transaction co-payment and no other violations are present, the POS transaction co-payment is covered according to the rules established for the COLLAT. Each employee may have a different COLLAT with unique rules that govern the distribution of funds therefrom. The employee may create the rules or select from a plurality of options. It is also envisioned that the employer may offer several Plan Designs and allow plan participants to select from the several options.

For another example, referring to FIG. 5 and Table 2, an additional example of a Plan Design with six transactions is shown. The six POS transactions are represented by arrows 160a-f respectively. The POS transactions 160a-f are received from the clients 104 via network 102. The clients 104 are preferably at the provider's establishment to acquire data when the plan participant swipes her program card to pay for the co-payment. It is also envisioned that periodic batch processing may be used and, therefore, a plurality of POS transactions may be received at the same time even though the POS transactions occurred at different times. Preferably, the period of the batch processing is daily, weekly or monthly. The network 102 serves as a business validation and logging unit in combination with transaction caching logic to execute the necessary functions. Also, the network 102 serves to distribute the POS transactions as can be understood from FIG. 5.

TABLE 2

| | | | | | | | | | | Post Tax/Credit |
|---|---|---|---|---|---|---|---|---|---|---|
| | Tier | Split | Tier | | Account | FSA/HRA | | | | line/other |
| Tier | Type | Amt. | Limit | Account | Balance | Contribution | DCA | Transportion | Parking | accounts |
| 1 | Non | N/A | $100 | FSA | $920 | $1,000 | 1,500 | $75 | $500 | $500 |
| | Split | | | | | $10,000 | | | | |
| 2 | % | 80% | $1000 | HRA | $9,936 | | | | | |
| | Split | 20% | | FSA | $884 | | | | | |
| | | | | | $9,776 | | | | | |
| | | | | | $844 | | | | | |
| 3 | $ | $20 | NA | FSA | $824 | | | | | |
| | Split | $40 | | HRA | $9,736 | | | | | |
| 1 | $ | $100 | NA | DCA | $1,400 | | | | | |
| | Split | $20 | | Post Tax | $480 | | | | | |
| 1 | $ | $75 | NA | Transp. | $0 | | | | | |
| | Split | $25 | | Post Tax | $455 | | | | | |

The plan design for the exemplary employee of FIG. 5 and Table 2 is arranged in three tiers 170, 172, 174. As would be recognized by those of ordinary skill in the art based upon review of the subject disclosure, there is no limit to the number of tiers or number of accounts within each tier. Tier one 170 has a FLAT FSA with a first amount of $100. Tier two 172 has two PLATs with an 80%/20% split and a limit of $1,000. The two PLATs of tier 172 are a FSA and a HRA. Tier three 174 is a Dollar Split tier or SLAT wherein a $20 and a $40 electronic transaction must be created before another account in the Plan Design can be debited. The Plan Design also includes a dependent care account (“DCA”) up to $1,500, a transportation account of $75/month, a parking account of $500 annually and an after tax account with a $500 limit. It is envisioned that the after tax account may be a credit line, associated with a bank account and the like to cover expenses that do not properly get parsed to one of the other accounts.

Still referring to FIG. 5, the six POS transactions 160a-f received by the transaction distribution unit (i.e., the network 102) are for $80, $100, $200, $60, $120 and $100, respectively. The transaction distribution unit parses the POS transactions 160a-f according to the rules associated with the employee's accounts as follows. The first POS transaction 160a of $80 comes completely from the FLAT as denoted by arrow 180 because the charge is less than the first amount of $100. The second POS transaction 160b of $100 is parsed into three different electronic transactions to be paid from three different accounts. The FLAT with the first amount of $100 still has $20 to be used. Thus, one electronic transaction for $20 is created and paid from the FLAT as denoted by arrow 181. The remaining $80 of the second POS transaction 160b is parsed into two more electronic transactions according to the split of the two PLATs. In particular, $16 and $64 electronic transactions, as denoted by arrows 182 and 183, are created according to the 80%/20% split yielding a $16 withdrawal from the first PLAT and a $64 withdrawal from the second PLAT.

The third POS transaction 160c for $200 generates two electronic transactions of $40 and $160, as denoted by arrow 184 and 185, to be paid from the first PLAT and second PLAT, respectively. The fourth POS transaction 160d for $60 also is parsed according to the 80%/20% split as denoted by arrows 186 and 187. The fifth POS transaction 160e for $120 is split into a $100 electronic transaction debited against the DCA as denoted by arrow 188 and a $20 transaction from the post tax account as denoted by arrow 189. The sixth POS transaction 160f for $100 is related to monthly parking. As a result, the sixth POS transaction 160f is parsed into a first electronic transaction of $75 debited against the parking account as denoted by arrow 190 and the remaining $25 amount becomes an electronic transaction debited against the post tax account as denoted by arrow 191.

Referring again to FIG. 3, still at step 316, after the POS transaction(s) have been parsed into electronic transactions for the appropriate accounts, the network 102 updates the account balances and proceeds to step 318. At step 318, the settlement by an exchange of funds with the credit card provider occurs and the process terminates.

At step 320, if the POS transaction was rejected, the network 102 determines whether or not to force post for the POS transaction. Transactions that are posted without authorization or adjudication are deemed pending. At a later date, further data is gathered by the PBM or third party substantiator to conduct the adjudication at a later time. Certain transactions may be debited against the employee's program card to insure that inappropriate denials do not occur. For example, the merchant may have a floor limit that defines an amount which if a transaction is below, no authorization is required. For more examples, a provider of goods and services may not have a data feed to the network 102 or the network 102 may be down. In the preferred embodiment, if such force posted POS transaction cannot be subsequently approved, the provider of goods and services absorbs the cost of rectification.

In another embodiment, the employer seeks rectification for improperly force posted POS transaction from the plan participant by garnishing wages or other suitable methods. If the POS transaction is not to be force posted, the network 102 proceeds to step 322 and the process terminates. If a POS transaction is force posted, posting occurs as described above and the process proceeds to step 316 to parse the POS transaction as described above.

While the hardware and data interaction of the invention has been described with respect to preferred embodiments, those skilled in the art will readily appreciate that various changes and/or modifications can be made to the invention without departing from the spirit or scope of the invention as defined by the appended claims.

1. A method for processing transactions associated with an employee, the method comprising the steps of:
establishing at least two linked accounts for the employee;
establishing at least one rule for governing how funds are withdrawn from the at least two linked accounts;
receiving funds for the at least two linked accounts;
receiving a transaction associated with the employee;
parsing the transaction into first and second electronic transactions according to the at least one rule;
authorizing payment of the first electronic transaction from a first account of the at least two linked accounts; and
authorizing payment of the second electronic transaction from a second account of the at least two linked accounts.

2. A method as recited in claim 1, further comprising the step of receiving the funds from an employer.

3. A method as recited in claim 1, further comprising the step of receiving the funds from the employee.

4. A method as recited in claim 1, wherein the at least one rule is selected from the group consisting of a split amount rule, a percentage rule, a flat amount rule and combinations thereof.

5. A method as recited in claim 4, wherein the flat amount rule has a first priority such that payment for the first transaction is determined by the flat amount rule.

6. A method as recited in claim 4, wherein the percentage rule has a ratio between two linked accounts that is selected by the employee.

7. A method as recited in claim 1, wherein the transaction is generated by swiping a magnetic strip on a card at a point of sale.

8. A method as recited in claim 1, further including the step of storing data relating to the employee and the at least two linked accounts in relational databases to be utilized during the authorizing steps.

9. A method as recited in claim 8, wherein the relational databases include IRS guidelines.

10. A computer readable medium whose contents cause a distributed computing environment to utilize a collection of tiers to fund a single POS transaction, the distributed computing environment having client computers and server computers, by performing the steps of:
receiving data relating to a POS transaction by a cardholder, the data including at least one monetary amount associated with a MCC;
determining whether the at least one monetary amount is reimbursable under IRS guidelines;
determining whether the at least one monetary amount is reimbursable according to rules that govern a collection of tiers associated with the cardholder;
parsing the at least one monetary amount into sub electronic transactions according to the rules; and
processing each sub electronic transaction in a different tier of the collection.

11. A computer readable medium as recited in claim 10, wherein the data further includes a card number and a MTC.

12. A computer readable medium as recited in claim 10, wherein the rules include determining if the at least one monetary amount is greater than an ATA.

13. A computer readable medium as recited in claim 10, wherein the rules include comparing the at least one monetary amount to a maximum amount for the MCC and a maximum amount for the collection, validating a valid MTC for the collection, and detemining if the cardholder is associated with an active employee of a company that sponsors the collection.

14. A computer for distributing payments between a plurality of accounts associated with a plan participant, the computer comprising:
memory for storing:
a program having instructions for creating a plurality of accounts being associated with and accessed by a plan participant, receiving a POS transaction of the plan participant and parsing the POS transaction into electronic transactions for processing from different accounts within the plurality of accounts; and
data related to the plan participant and the plurality of accounts; and
a processor operatively connected to the memory for running the program and accessing the data as necessary.

15. A computer as recited in claim 14, wherein the plan participant is an employee of a company administering the plurality of accounts.

16. A computer as recited in claim 14, wherein the plan participant access the accounts by swiping a card to generate the POS transaction.

17. A system for processing transactions associated with an employee comprising:
first means for establishing at least two linked accounts for the employee;
second means for establishing at least one rule for governing how finds are withdrawn from the at least two linked accounts;
third means for receiving funds for the at least two linked accounts;
fourth means for receiving a transaction associated with the employee;
fifth means for parsing the transaction into first and second electronic transactions according to the at least one rule;
sixth means for authorizing payment of the first electronic transaction from a first account of the at least two linked accounts; and
seventh means for authorizing payment of the second electronic transaction from a second account of the at least two linked accounts.

18. A system as recited in claim 17, wherein the first, second, third, fourth, fifth, sixth and seventh means are computers.
